(19) United States
(12) Patent Application Publication
(10) Pub. No.: US 2024/0168801 A1
(43) Pub. Date: May 23, 2024

(54) ENSURING QUALITY OF SERVICE IN MULTI-TENANT ENVIRONMENT USING SGLS

(71) Applicant: Western Digital Technologies, Inc., San Jose, CA (US)

(72) Inventors: Amir SEGEV, Meiter (IL); Shay BENISTY, Beer Sheva (IL)

(73) Assignee: Western Digital Technologies, Inc., San Jose, CA (US)

(21) Appl. No.: 18/359,674

(22) Filed: Jul. 26, 2023

Related U.S. Application Data
(60) Provisional application No. 63/427,159, filed on Nov. 22, 2022.

(51) Int. Cl. G06F 9/48

(52) U.S. Cl. CPC G06F 9/4881

(57) ABSTRACT

The present disclosure generally relate to improved tenant processing by arbitration of commands. Rather than processing a tenant with multiple portions to completion causing increased wait time for preceding tenants, allowing the controller to process commands based on the respective bandwidth allocated to each tenant is beneficial. Through a Weighted Round Robin (WRR) arbiter, the controller is able to allocate a percentage of the bandwidth to each tenant based on the tenant's needs. Once the bandwidth is allocated to the tenants, the controller may then process portions of the commands from the tenants up to the allocated bandwidth per tenant, which avoids the need for commands that are fetched after earlier commands wait for previous commands to complete their processing, but instead process all command portions based on the allocated bandwidth from the WRR arbiter.

### CROSS-REFERENCE TO RELATED APPLICATIONS

This application claims benefit of U.S. provisional patent application Ser. No. 63/427,159, filed Nov. 22, 2022, which is herein incorporated by reference.

### BACKGROUND OF THE DISCLOSURE

### Field of the Disclosure

Embodiments of the present disclosure generally relate to improved tenant processing by ensured arbitration of commands.

### Description of the Related Art

For a controller to transfer data to and from a host device, the data storage device requires an address on the host side. One method of conveying the addresses on the host side is called a Scatter Gather List (SGL). However, whenever a data storage device fetches an SGL segment, the controller device does not know the status of the SGL segment. As a result, the controller device might take very long to process the command as received.

In previous approach when a device controller receives a bad SGL segment, the controller delays processing of commands that follow. For example, if SGL for command 1 is fetched by the controller and is found to be a bad SGL segment, the next command (command 2) that is waiting to be executed gets delayed. The controller will keep trying to process the SGL of command 1 and will succeed, but will delay processing of command 2. The process of reading SGL of command 1 and failing will loop over and over again. Only once the controller finally completes command 1 SGL processing, the controller can move to the SGL of command 2. The approach leads to increased system degradation and decreased Quality of Service (QoS).

Therefore, there is a need in the art for improved tenant processing by arbitration of commands.

### SUMMARY OF THE DISCLOSURE

The present disclosure generally relate to improved tenant processing by arbitration of commands. Rather than processing a tenant with multiple portions to completion causing increased wait time for preceding tenants, allowing the controller to process commands based on the respective bandwidth allocated to each tenant is beneficial. Through a Weighted Round Robin (WRR) arbiter, the controller is able to allocate a percentage of the bandwidth to each tenant based on the tenant's needs. Once the bandwidth is allocated to the tenants, the controller may then process portions of the commands from the tenants up to the allocated bandwidth per tenant, which avoids the need for commands that are fetched after earlier commands to wait for previous commands to complete their processing, but instead process all command portions based on the allocated bandwidth from the WRR arbiter.

In one embodiment, a data storage device comprises: a memory device; and a controller coupled to the memory device, wherein the controller is configured to: allocate first bandwidth of total bandwidth to a first tenant; allocate second bandwidth of the total bandwidth to a second tenant; and arbitrate data transfer requests between the first tenant and the second tenant based upon the allocated first and second bandwidths.

In another embodiment, a data storage device comprises: a memory device; and a controller coupled to the memory device, wherein the controller comprises: a PCIe bus; a control path; and a data path, wherein the data path comprises: a write handler including a weighted round robin arbiter; a scatter gather list (SGL) fetching module coupled to the write handler; a direct memory access (DMA) module coupled to the SGL fetching module; a cached memory module coupled to the DMA module; and a flash interface module (FIM) coupled to the memory device and the cached memory module.

In another embodiment, a data storage device comprises: memory means; and a controller coupled to the memory means, wherein the controller is configured to: process scatter gather list (SGL) commands for multiple virtual hosts based upon bandwidth assigned to individual virtual hosts of the multiple virtual hosts and wherein SGL commands for the multiple virtual hosts are processed consecutively.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is an illustrative example of a SGL structure, according to certain embodiments.

FIG. 3 is an example flow of how SGLs are fetched from a host, according to certain embodiments.

FIG. 4 is a schematic block diagram illustrating a system with control write path, according to certain embodiments

FIG. 5 is a schematic block diagram illustrating a system with an arbiter, according to certain embodiments.

FIG. 6 is a schematic diagram illustrating a method for processing a portion of commands based on a bandwidth threshold, according to certain embodiments.

FIG. 7 is a schematic illustration of a graph of bandwidth distribution over a period of time for a set number of tenants, according to certain embodiments.

FIG. 8 is a flow chart illustrating a method for processing a portion of commands based on bandwidth allocation, according to certain embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relate to improved tenant processing by arbitration of commands. Rather than processing a tenant with multiple portions to completion causing increased wait time for preceding tenants, allowing the controller to process commands based on the respective bandwidth allocated to each tenant is beneficial. Through a Weighted Round Robin (WRR) arbiter, the controller is able to allocate a percentage of the bandwidth to each tenant based on the tenant's needs. Once the bandwidth is allocated to the tenants, the controller may then process portions of the commands from the tenants up to the allocated bandwidth per tenant, which avoids the need for commands that are fetched after earlier commands to wait for previous commands to complete their processing, but instead process all command portions based on the allocated bandwidth from the WRR arbiter.

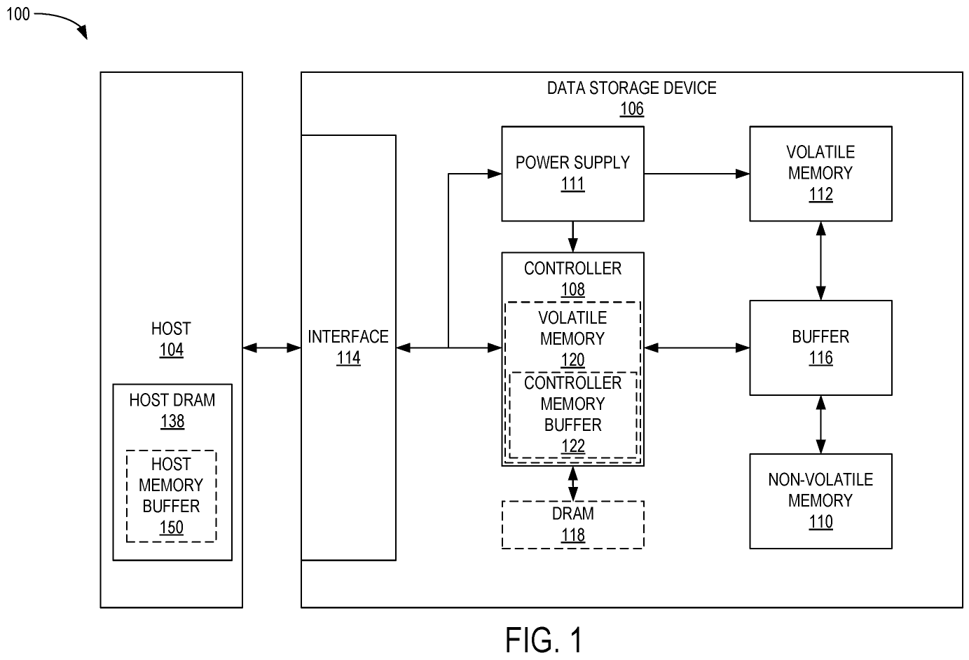

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe ×1, ×4, ×8, ×16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

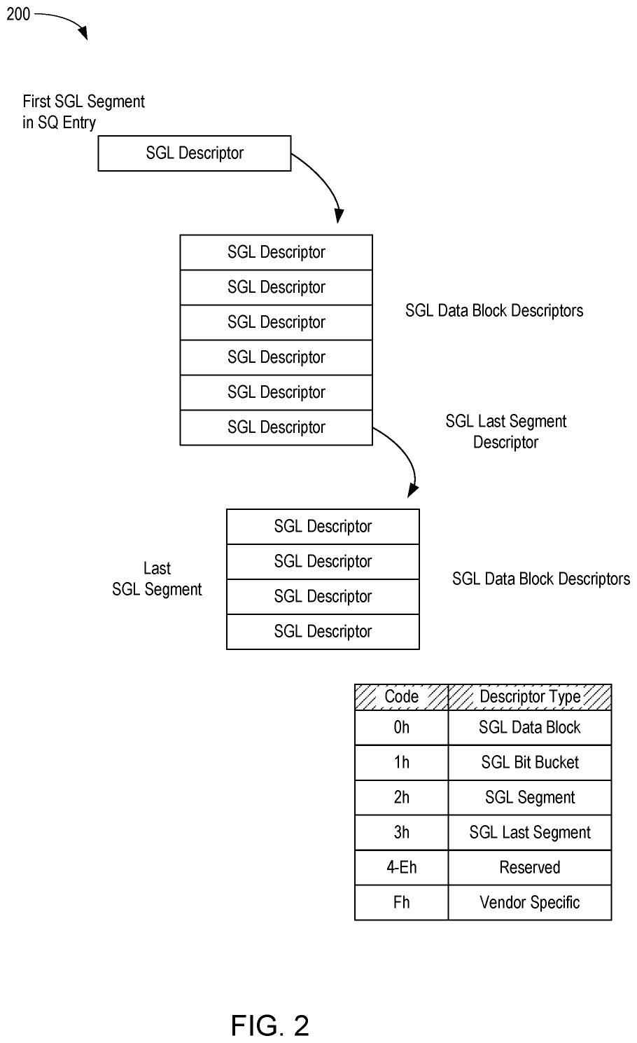

FIG. 2 is an illustrative example 200 of a SGL structure, according to certain embodiments. When a data storage device receives a command, the command contains the first pointer of an SGL. The last SGL descriptor of a section points to the first SGL descriptor of the following section. The second section is the next SGL segment with 5 SGL data blocks and one pointer pointing to a last SGL segment. The third section is the last SGL segment and is comprised of 4 SGL data blocks. In this illustrative example, in total, the command comprises 9 different pointers.

The standard allows SGL segments and SGL data blocks to be of any size. Therefore, the command and the 9 different pointers may cover anywhere from zero bytes to 512 bytes to 512 MB and more in size. The standard even allows for a single segment to be as big as 256K entries.

When the device fetches the second SGL segment, the device does not know what size the third segment will be, or if a third segment even exists. If the device needs to fetch pointers for 4K out of a 16K command, then it may be enough to fetch only the first entry of the SGL, or possibly all entries.

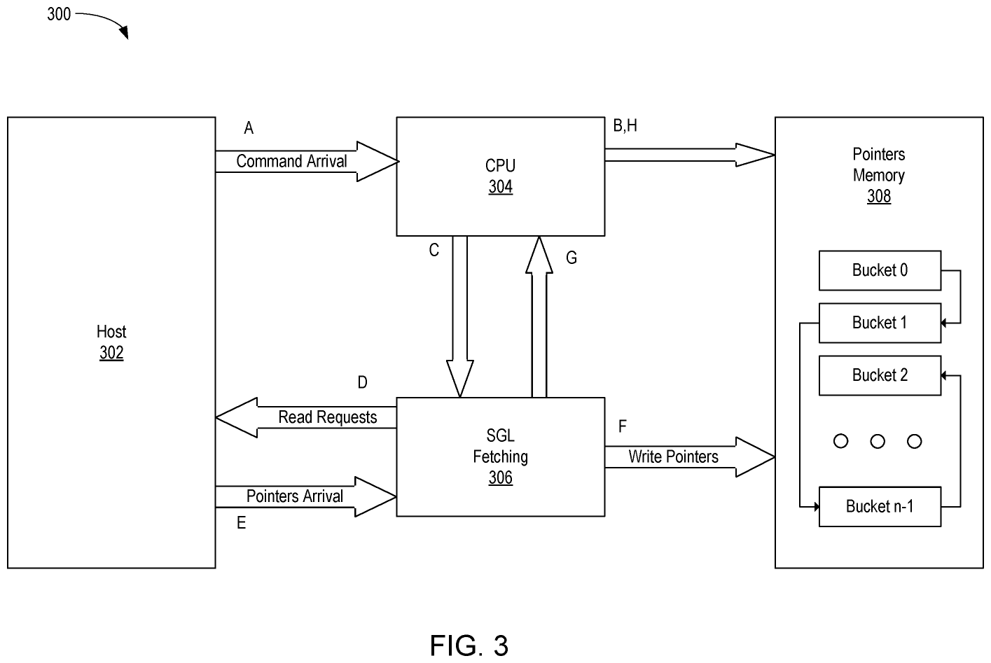

FIG. 3 is an example flow 300 of how SGL are fetched from a host, according to certain embodiments. Letters have been assigned to arrows to display the order of the flow.

The flow 300 first starts with a host 302 sending a command which arrives at the CPU 304 with step A. Once the CPU 304 has received the command, the CPU 304 adjusts a value “remaining_bucket_size” representing the remaining number of SGL entries in a new segment. Next, the CPU 304 finds a portion of memory, a local-bucket in this instance, which is free to write to with step B. Each local-bucket in memory 308 supports up to N SGL entries.

Once a free bucket is selected, the CPU 304 requests for the hardware to fetch SGL entries and to fill the memory space available in the local-bucket with step C. The request is sent to the SGL fetching module 306. During step D, the SGL fetching module 306 performs a read of either all of local-bucket (N entries), or as many SGL entries as remain available as was determined during step A. The fetching is according to the algorithm F=MIN(N, remaining_bucket_size). As a result of fetching the values gets updated. After the SGL fetching module 306 attempts to fetch the SGL entries, the total number of remaining SGL entries remaining to be fetched is updated (remaining_bucket_size) and lowered with the total amount of SGL entries fetched (F) and the same goes for remaining memory local-bucket size, which is updated and lowered by the amount of memory written to (N=N−F).

The host 302 receives the request for SGL entries from the SGL fetching module 306 and sends pointers associated with the SGL entries back to the SGL fetching module 306 with step E. If there are still SGL entries remaining to be fetched and there is room in the local-bucket (i.e., if N>0), the flow returns to step D until all SGL entries have been fetched and the bucket is full.

The SGL fetching module 306 then writes the pointers to the dedicated memory with step F. The CPU 304 is reported to with the results of the fetching with step G. Finally, with Step H, using the information from step G, the CPU 304 can then allocates another bucket (of N entries) if needed and links the bucket to the previous bucket and repeats back to step C. Buckets 0 and 1, 1 and n−1, and n−1 and 2 are shown to be linked in FIG. 3.

Since SGL sizes are not guaranteed and can be as small as 1 byte each, the number of repetitions between steps C and H until the device holds enough SGLs for a single FMU might vary. Such SLGs are often called ‘bad SGLs’. Bad SGLs impose several unpredictable reds to fetch the host pointers. Each such read has a long turnaround time.

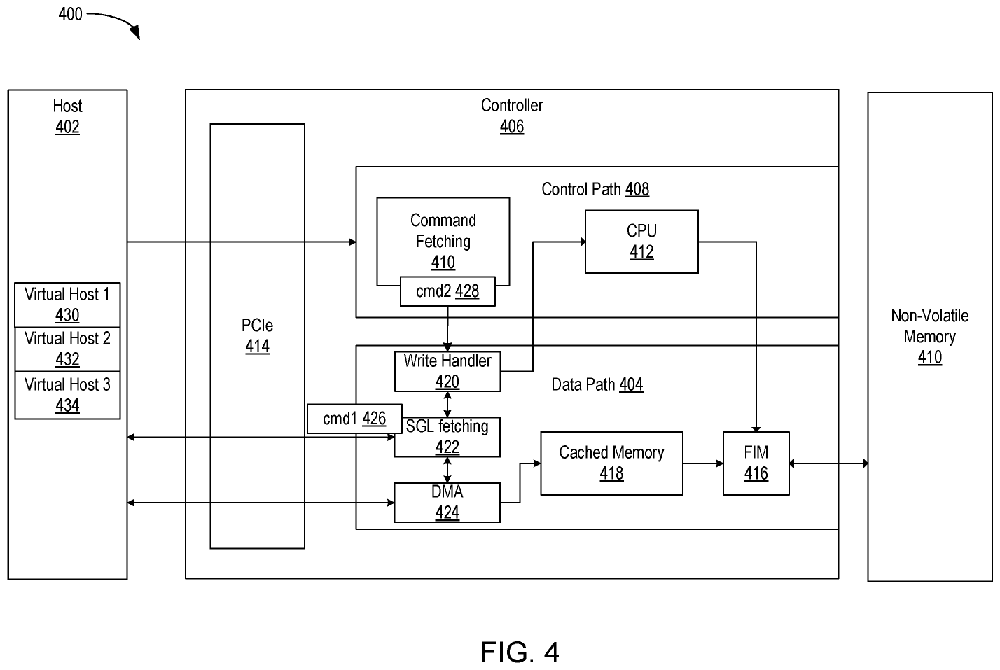

FIG. 4 is a schematic block diagram illustrating a system 400 with double indirect key index lists, according to certain embodiments. FIG. 4 shows a host 402 with three virtual hosts (430, 432, and 434), a controller 406, and a NVM 410. For example when a command is detected by the control path 408, the command is sent to the data path 404. The write handler module420 will then trigger the SGL fetching 422. Once completed the DMA 424 will transfer data to the NVM 410. The system 400 may function as a storage device for the host 402. For instance, the host 402 may utilize NVM 410 to store and retrieve data.

The host 402 includes, virtual host 1 430, virtual host 2 432, and virtual host 3 434. Commands are fetched from the controller device 406 from any of the virtual hosts 430, 432, and 434. The data storage device 406 includes the control path 408, the data path 404, and a PCIe bus 414. Control path 408 includes a command fetching module 410 configured to detect write commands then sends the commands to the data path 404 and not the CPU 412. Control path 408 further includes a CPU 412. As an example, cmd2 428 is a command that comprises an SGL to be fetched by the command fetching module 410. Data path 404 includes a FIM 416 configured to send and receive data from the NVM 410. Data path 404 further includes a write handler module 420 configured to receive a command. Data path 404 further includes a SGL fetching 422. The SGL fetching module 422 is triggered by the write handler module 420 to fetch incoming commands. Commands may include but not limited to cmd1 426 and cmd2 428. The cmd1 426 will be processed before cmd2 428. If the SGL in cmd1 426 is a bad SGL then the SGL in cmd2 428 will get delayed. Data path 404 further includes a cached memory 418 configured to hold data. The write handler module 420 informs the CPU 412 to trigger the direct memory access (DMA) 424 of the data path 404 to write the data to the NVM 410.

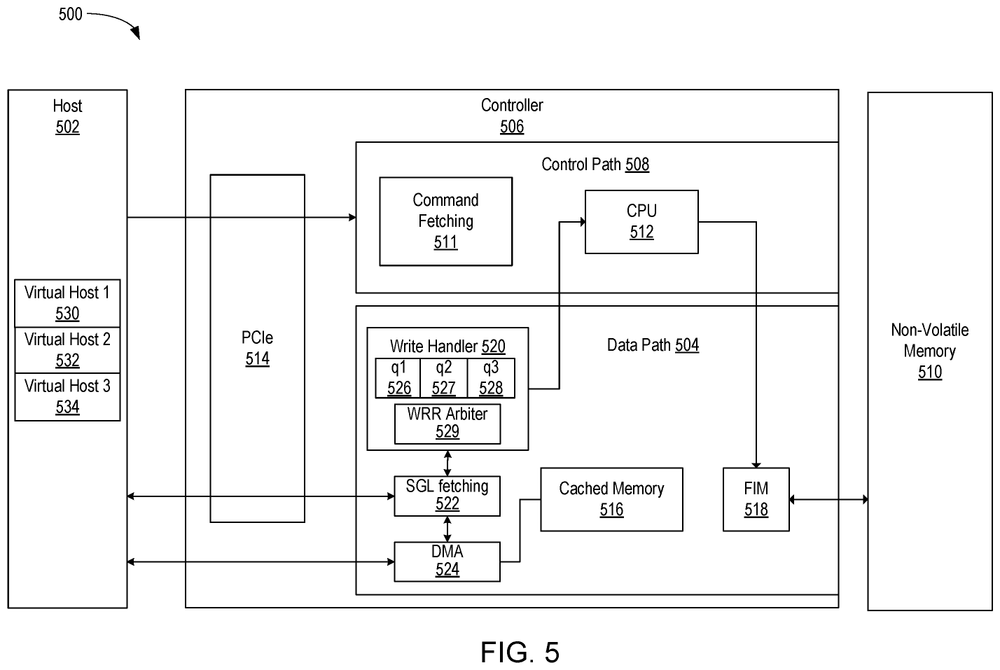

FIG. 5 is a schematic block diagram illustrating a system 500 with an arbiter, according to certain embodiments. FIG. 5 shows a host 502 with three virtual hosts (530, 532, and 534), a controller 506, and a NVM 510. When a command is detected by the control path 508, the command is sent to the data path 504. The write handler module 520 of the data path 504 will ensure there are enough host pointers to service the data transfer. The write handler module 520 then triggers the queue per tenant (526, 527, and 528) to run the commands as arrived. If a command that is fetched is bad SGL then the queue per tenant (526, 527, and 528) will ensure the fetch of the next commands will not wait for the bad-sgl to complete. The system 500 may function as a storage device for the host 502. For instance, the host 502 may utilize NVM 510 to store and retrieve data.

The host 502 includes, virtual host 1 530, virtual host 2 532, and virtual host 3 534. Commands are fetched from the controller device 506 from any of the virtual hosts (530, 532, and 534). The data storage device 506 includes a control path 508, a data path 504, and a PCIe bus 514. Control path 508 includes a command fetching module 511 configured to detect commands as write commands then sends them to the data path 504. Control path 508 further includes a CPU 512. Data path 504 includes a FIM 516 configured to send and receive data from the NVM 510. Data path 504 further includes a write handler module 520 configured to receive commands that are fetched by the command fetching module 511. Write handler module 520 comprises a que per tenant 1 526, a que per tenant 2 527, a que per tenant 3 528 configure to support multiple (one per tenant) write commands in parallel. Write handler module 520, further comprises a WRR arbiter 529 which allow command SGL (and data) fetching of other commands if a prior command (from different que 256,257,258 has a bad SGL command. Data path 504 further includes a SGL fetching module 522. The SGL fetching module 522 is triggered by the write handler module 520 to fetch incoming commands. Data path 504 further includes a cached memory 518, configured to hold data. The write handler module 520 informs the CPU 512 to trigger the direct memory access (DMA) 524 of the data path 504 to write the data to the NVM 510.

The write handler module 520 holds a queue per tenant and a FMU arbiter 529. Whenever a write command arrives, the write command is classified to the appropriate internal queue where all queues compete over SGL and data transferring triggering. Each of the queues is asking to service a single 4K at a time. The WRR arbiter 529 is added to ensure arbitration based upon the different quality of service requirements per tenant.

Before arbitrating on the transfer request, the write handler module 520 must ensure that the write handler module has enough host pointers to service the data transfer. As such, the write handler module 520 will wait for a response before the write handler module 520 may move on. When working in order (i.e., one command at a time) due to a bad SGL the phase will take a lot of iterations and will cause head of the line blocking to other commands. As discussed herein, due to the separate queues per tenant, the host pointers fetching of commands from other queues can start earlier and are not blocked by the first command.

In other embodiments, the exact same flow can be used to improve quality of service of write commands even when there is no bad SGL. There would be no head of the line blocking of short commands by long commands and the weight of the WRR arbiter 529 can be used to differentiate between different quality of service requirements per tenant, at a better granularity than doing so on a per command basis. For example, if tenant 1 requires 50% of the bandwidth and tenant 2 and tenant 3 require 25% each with the wrights provided to the WRR arbiter 529 to be 2:1:1.

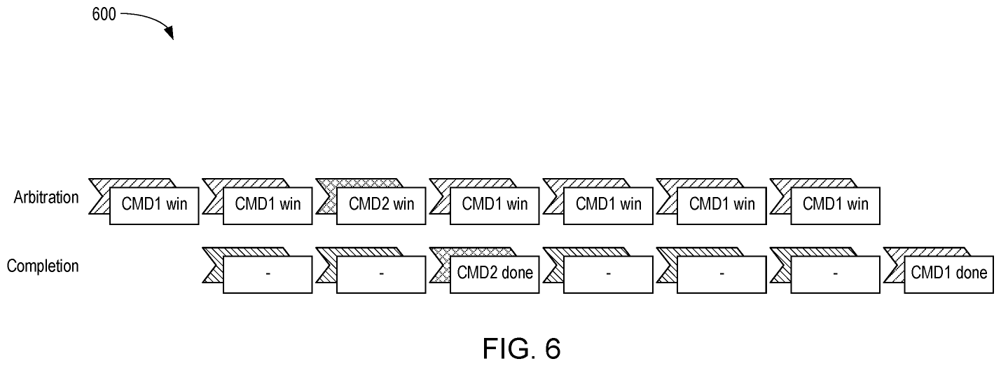

FIG. 6 is a schematic diagram illustrating a method 600 for processing commands, according to certain embodiments. For the example, there is a CMD1 and a CMD2, and though only two commands are shown there may be more or less commands present in other scenarios. In FIG. 6, the CMD1 is taking two slots (since CMD1 has a weight of 2), however data transfer and completion are not done after those two slots, as the command is 6 flash management units (FMU) long.

The CMD2 is taking one slot, in which the command completes, before CMD1 is done, which takes another 4 slots. The flow ensures that CMD2 (from tenant 3 for example) is not delayed due to the length of the command CMD1 provided by tenant 1. By adding a queue per tenant (or other type of classification) and WRR arbitration per FMU, QoS for write commands is ensured, and better weight control is provided.

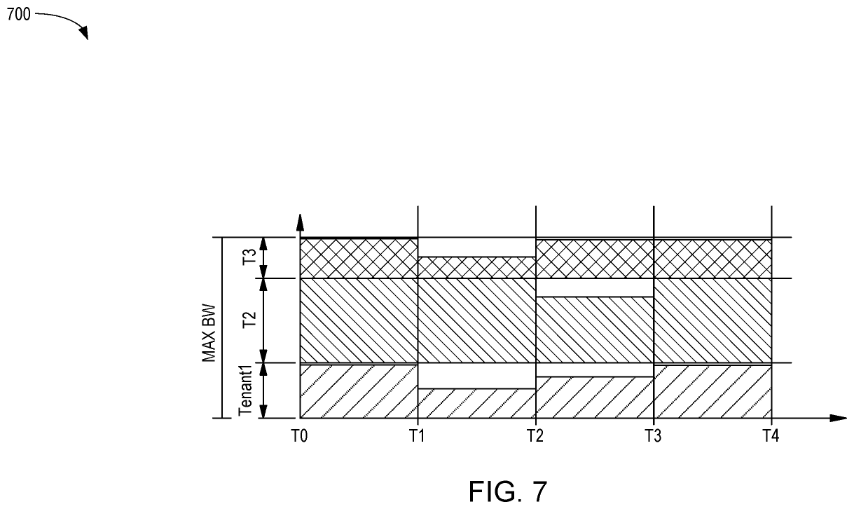

FIG. 7 is a schematic illustration of a graph 700 of bandwidth distribution over a period of time for a set number of tenants, according to certain embodiments. The graph 700 illustrates the bandwidth utilization of a WRR, such as the WRR arbiter 529 of FIG. 5, where the x-axis represents time (T) and the y-axis represents a bandwidth utilization. The maximum bandwidth (MAX BW) represents the maximum bandwidth of the WRR arbiter 529, where the maximum bandwidth is the maximum bandwidth that exists between a controller, such as the controller 506 of FIG. 5, and a host, such as the host 504 of FIG. 5.

The bandwidth is split between each tenant, such as each virtual host of the host 504. Each of the tenants is allocated a guaranteed bandwidth, where the guaranteed bandwidth may be the same or different between each of the tenants. As illustrated in the graph 700 write bandwidth has guaranteed bandwidths for Tenant1 and guaranteed bandwidths for both Tenant2 and Tenant3.

Write bandwidth displays a guaranteed bandwidth for Tenant2 that is greater than the guaranteed bandwidths for both Tenant1 and Tenant 3. The WRR arbiter 529 will receive the provided weights of each tenant and will allocate the guaranteed bandwidth to each tenant. The provided weight will guarantee that a portion of the write bandwidth are allocated to each tenant. If a tenant does not use all of their respective guaranteed bandwidth then another tenant may use the bandwidth. This is only if the tenant that the bandwidth is allocated for does not need to use the bandwidth. Separate allocated bandwidths allow the system to run multiple tenant commands avoiding the delay from a prior longer command to be finished.

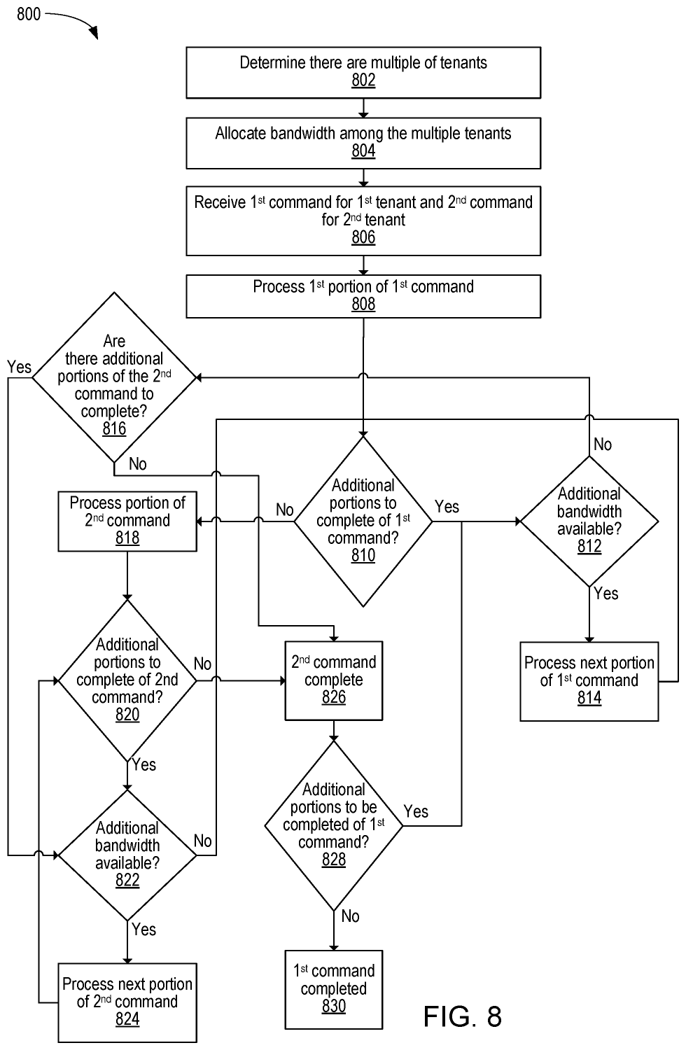

FIG. 8 is a flow chart illustrating a method 800 for processing a portion of commands based on bandwidth allocation, according to certain embodiments. The method 800 may describe the processing of commands through the use of a WRR arbiter, such as the WRR arbiter 529 of FIG. 5. A command may have multiple portions that need to be read by a controller, such as the controller 506 of FIG. 5. When a controller has fetched an SGL of a command with multiple portions, the WRR arbiter allows a few of the portions to be written. This is allowed since the WRR arbiter allocates a specific amount of bandwidth needed for said command. Now that the command has allocated space, the controller may now fetch another command with a designated bandwidth amount to be written. The command will be written without the delay of waiting for the previous command to complete only if enough bandwidth is available.

Method 800 begins at block 802. At block 802 a controller, such as the controller 506 of FIG. 5 determines that there are multiple tenants. Each tenant may have multiple portions. At block 804, bandwidth is allocated amongst the multiple tenants. At block 806, the controller receives a first command from the first tenant and a second command from the second tenant. At block 808, the controller processes the first portion of the first command. At block 810, the controller determines if there are any additional portions to be completed of the first command. If the controller determines that there are no additional portions then method 800 will proceed to block 818 to process a portion of a second command if there is a second command. If the controller determines that there are additional portions of the first command to be completed then method 800 will proceed to block 812. At block 812, the controller determines if there is any additional bandwidth for tenant 1. If there is addition bandwidth available then that additional portion of the first command will be processed at block 814 and then return to block 810. If there is no additional bandwidth available then method 800 proceeds to block 816. At block 816, the controller determines if there are any additional portions of a second command to be completed. If there are no additional portions of a second command then the second command is completed at block 826. If there are additional portions of the second command to be completed then method 800 proceeds to block 822 to determine if there is any additional bandwidth for tenant 2 available.

At block 818, the controller processes the second command after the determining at block 810 that there are no additional portions of the first command to complete. Method 800 proceeds to block 820 at the completion of block 818, at block 820 the controller determines if there are any additional portions of the second command that need to be completed. If the controller determines that there are no additional portions to be completed then the second command is completed at block 826. If the controller determines that there are additional portions of the second command to be completed then method 800 proceeds to block 822. At block 822, the controller determines if there is any additional bandwidth available. If the controller determines that there is additional bandwidth, then method 800 will proceed to block 824. At block 824, the controller processes the next portion of the second command and then returns to block 820. If the controller determines that there is no additional bandwidth available then method 800 proceeds to block 810. At the completion of the second command at block 826, method 800 proceeds to block 828. At block 828 the controller determines if there are any additional portions of the first command to be completed. If there are no additional portions to be completed then method 800 proceeds to block 830 where command one is completed. If the controller determines that there are additional portions to be completed then method 800 returns to block 812 to determine if there is any additional bandwidth available.

As an example, the controller determines at block 802 there are multiple tenants. At block 804, the controller device allocates 75% of the bandwidth to the first tenant and allocates 25% of the bandwidth to the second tenant. The first tenant now has 3 portions of allocated bandwidth (e.g., enough bandwidth for 3 FMUs) while the second tenant has 1 portion of allocated bandwidth. At block 806 the device controller receives the first command from the first tenant and the second command from the second tenant. At block 808, the controller device processes the first portion of the first command. At block 810, the controller device determines that there are additional portions to complete of the first command so method 800 will proceed to block 812. At block 812, the controller device determines if that there is any additional bandwidth. Since there is additional bandwidth the second portion of the first command will be processed at block 814 and then return to block 810. The controller again determines if there is an additional portion of the first command that needs to be completed. Since there is an additional portion method 800 will proceed to block 812. At block 812, the device determines if there is any additional bandwidth. Because there is additional bandwidth available method 800 will proceed to block 814 to process the additional portion. Method 800 will proceed to block 810. Because the first command has been processed and there are no additional portions of the first command to process, the method 800 will proceed to block 818. Hypothetically, if the first command had four portions rather than three portions, then method 800 would proceed from block 810 to block 812 and then block 816 because there would not be sufficient bandwidth to process the hypothetical fourth portion of the first command. Returning to the example where the first command has three portions and all three portions have been completed, At block 818 the controller processes a portion of the second command that needs to be completed and then determines whether there are additional portions of the second command to complete at block 820. Because the second command had only one portion, there are no additional portions of the second command to complete, and thus the second command is complete at block 826.

It is to be understood that even though in this example the first tenant has 75% bandwidth allocated and 25% bandwidth allocated to the second tenant, there can be more tenants that may have more or less bandwidth allocated to their respective commands. Though, the total bandwidth allocated between the pluralities of tenants is not to exceed 100%.

As another example, consider the situation where there are two tenants, each with a command. The first tenant is allocated 75% of the bandwidth (e.g., enough for 3 FMUs), and second tenant is allocated 25% of the bandwidth (e.g., enough for 1 FMU). The first tenant has a first command with four portions (e.g., 4 FMUs) and the second tenant has a second command with two portions (e.g., 2 FMUs). The commands would be processed as follows.

The first portion of the first command would be processed at 808. Thereafter, a determination is made regarding whether there are additional portions of the first command to complete at block 810. Because there are three additional portions to complete, the answer is yes and a determination is made regarding whether there is sufficient bandwidth available at 812. Again, because the answer is yes, the second portion of the first command is processed at block 814 and then a determination is made regarding whether there are additional portions of the first command to complete at block 810. Because there are two additional portions to complete, the answer is yes and a determination is made regarding whether there is sufficient bandwidth available at 812. Again, because the answer is yes, the third portion of the first command is processed at block 814 and then a determination is made regarding whether there are additional portions of the first command to complete at block 810. Because there is still the fourth portion of the first command to complete, the answer is yes and a determination is made regarding whether there is sufficient bandwidth to available at block 812. Because there is not sufficient bandwidth available, the method 800 proceeds to block 816 where a determination is made regarding whether there are portions of the second command to complete. Because there are two portions of the second command to complete, the answer is yes and then a determination is made at block 822 regarding whether there is sufficient bandwidth available. Because there is sufficient bandwidth available, the first portion of the second command is processed at block 824. Thereafter, a determination is made at 820 regarding whether there are additional portions of the second command to complete. Because there is still the second portion of the second command to complete, a determination is made regarding whether there is sufficient bandwidth available at block 822. There is not sufficient bandwidth available at block 822 and therefore, the method 800 proceeds back to block 810 where a determination is made regarding whether there are additional portions of the first command to complete. The fourth portion of the first command has not completed and therefore, the answer is yes and a determination is made at block 812 regarding whether there is sufficient bandwidth available. Because there is sufficient bandwidth available, the fourth portion of the first command is processed at block 814 and then a determination is made at block 810 regarding whether there are any additional portion of the first command to complete. Because there are no additional portions of the first command to complete, the second portion of the second command can be processed at block 818. Finally, a determination is made regarding whether there are any additional portions of the second command to complete at block 820. Because there are no additional portions of the second command to complete, the second command is complete at block 826.

Advantages this disclosure is that the controller will not experience head-of-line blocking due to bad SGLs or long commands. In addition, commands will process based on bandwidth allocation to avoid command wait time. Furthermore, there is a finer control over the different QoS requirements between multiple tenants.

In one embodiment, a data storage device comprises: a memory device; and a controller coupled to the memory device, wherein the controller is configured to: allocate first bandwidth of total bandwidth to a first tenant; allocate second bandwidth of the total bandwidth to a second tenant; and arbitrate data transfer requests between the first tenant and the second tenant based upon the allocated first and second bandwidths. The arbitration comprises: beginning processing of a first command for the first tenant; and beginning processing of a second command for the second tenant, wherein processing of the second command begins prior to completion of processing the first command. The controller comprises a data path and a control path, wherein the data path comprises: a write handler; a flash interface module (FIM); a scatter-gather list (SGL) fetching module; a direct memory access (DMA) module; and a cached memory module. The write handler comprises: an arbiter; a first queue corresponding to the first tenant; and a second queue corresponding to the second tenant. The first queue and the second queue each service a single 4K Byte at a time. The arbiter is a weighted round robin arbiter. The arbiter is a FMU sized arbiter. The controller comprises a weighted round robin arbiter. The weighted round robin arbiter is configured to allocate bandwidth for scatter-gather list (SGL) fetching and data-fetching, and the bandwidth allocations. In one embodiment, the bandwidth allocations are identical. In another embodiment, the bandwidth allocations are different. In another embodiment, the bandwidth allocations for SGL fetching and data-fetching for data corresponding to the SGL fetching is different. In another embodiment, the bandwidth allocations for SGL fetching and data-fetching for data corresponding to the SGL fetching is identical. The first tenant corresponds to a first virtual host and the second tenant corresponds to a second virtual host.

In another embodiment, a data storage device comprises: a memory device; and a controller coupled to the memory device, wherein the controller comprises: a PCIe bus; a control path; and a data path, wherein the data path comprises: a write handler including a weighted round robin arbiter; a scatter gather list (SGL) fetching module coupled to the write handler; a direct memory access (DMA) module coupled to the SGL fetching module; a cached memory module coupled to the DMA module; and a flash interface module (FIM) coupled to the memory device and the cached memory module. The write handler further comprises a plurality of queues, wherein each queue of the plurality of queues corresponds to a virtual host. The weighted round robin arbiter is configured to assign slots to a corresponding queue of the plurality of queues based upon bandwidth assigned to the virtual hosts. The controller is configured to process a first command from a first queue of the plurality of queues prior to completing processing of a second command from a second queue of the plurality of queues. The second queue utilizes more bandwidth than the first queue. At least one queue of the plurality of queues has a different quality of service (QoS) compared to at least one other queue of the plurality of queues. The control path comprises a command fetching module for fetching commands and wherein the SGL fetching module fetches SGLs for the fetched commands.

In another embodiment, a data storage device comprises: memory means; and a controller coupled to the memory means, wherein the controller is configured to: process scatter gather list (SGL) commands for multiple virtual hosts based upon bandwidth assigned to individual virtual hosts of the multiple virtual hosts and wherein SGL commands for the multiple virtual hosts are processed consecutively. The controller is configured to pause processing a first SGL command prior to completing the first SGL command. The controller is further configured to process a second SGL command prior to completing the first SGL command, wherein the second SGL command begins processing after the first SGL command processing begins, and wherein the first SGL command and the second SGL commands are from separate and distinct virtual hosts of the multiple virtual hosts.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
allocate first bandwidth of total bandwidth to a first tenant;
allocate second bandwidth of the total bandwidth to a second tenant; and
arbitrate data transfer requests between the first tenant and the second tenant based upon the allocated first and second bandwidths.

2. The data storage device of claim 1, wherein the arbitration comprises:
beginning processing of a first command for the first tenant; and
beginning processing of a second command for the second tenant, wherein processing of the second command begins prior to completion of processing the first command.

3. The data storage device of claim 1, wherein the controller comprises a data path and a control path, wherein the data path comprises:
a write handler;
a flash interface module (FIM);
a scatter-gather list (SGL) fetching module;
a direct memory access (DMA) module; and
a cached memory module.

4. The data storage device of claim 3, wherein the write handler comprises:
an arbiter;
a first queue corresponding to the first tenant; and
a second queue corresponding to the second tenant.

5. The data storage device of claim 4, wherein the first queue and the second queue each service a single 4K Byte at a time.

6. The data storage device of claim 4, wherein the arbiter is a weighted round robin arbiter.

7. The data storage device of claim 3, wherein the arbiter is a flash management unit (FMU) sized arbiter.

8. The data storage device of claim 1, wherein the controller comprises a weighted round robin arbiter.

9. The data storage device of claim 8, wherein the weighted round robin arbiter is configured to allocate bandwidth for scatter-gather list (SGL) fetching and data-fetching.

10. The data storage device of claim 1, wherein the first tenant corresponds to a first virtual host and the second tenant corresponds to a second virtual host.

11. A data storage device, comprising:
a memory device; and
a controller coupled to the memory device, wherein the controller comprises:
a PCIe bus;
a control path; and
a data path, wherein the data path comprises:
a write handler including a weighted round robin arbiter;
a scatter gather list (SGL) fetching module coupled to the write handler;
a direct memory access (DMA) module coupled to the SGL fetching module;
a cached memory module coupled to the DMA module; and
a flash interface module (FIM) coupled to the memory device and the cached memory module.

12. The data storage device of claim 11, wherein the write handler further comprises a plurality of queues, wherein each queue of the plurality of queues corresponds to a virtual host.

13. The data storage device of claim 12, wherein the weighted round robin arbiter is configured to assign slots to a corresponding queue of the plurality of queues based upon bandwidth assigned to the virtual hosts.

14. The data storage device of claim 13, wherein the controller is configured to process a first command from a first queue of the plurality of queues prior to completing processing of a second command from a second queue of the plurality of queues.

15. The data storage device of claim 14, wherein the second queue utilizes more bandwidth than the first queue.

16. The data storage device of claim 12, wherein at least one queue of the plurality of queues has a different quality of service (QoS) compared to at least one other queue of the plurality of queues.

17. The data storage device of claim 11, wherein the control path comprises a command fetching module for fetching commands and wherein the SGL fetching module fetches SGLs for the fetched commands.

18. A data storage device, comprising:
memory means; and
a controller coupled to the memory means, wherein the controller is configured to: process scatter gather list (SGL) commands for multiple virtual hosts based upon bandwidth assigned to individual virtual hosts of the multiple virtual hosts and wherein SGL commands for the multiple virtual hosts are processed consecutively.

19. The data storage device of claim 18, wherein the controller is configured to pause processing a first SGL command prior to completing the first SGL command.

20. The data storage device of claim 19, wherein the controller is further configured to process a second SGL command prior to completing the first SGL command, wherein the second SGL command begins processing after the first SGL command processing begins, and wherein the first SGL command and the second SGL commands are from separate and distinct virtual hosts of the multiple virtual hosts.
